(19) United States
(12) Patent Application Publication
(10) Pub. No.: US 2020/0379798 A1
(43) Pub. Date: Dec. 3, 2020

(54) APPARATUS FOR TRANSMITTING PACKETS USING TIMER INTERRUPT SERVICE ROUTINE

(71) Applicant: Open Stack, Inc., Seongnam-si (KR)

(72) Inventors: Jae Guon NAM, Seongnam-si (KR); Ho Jin CHOI, Seongnam-si (KR); Chan Hyuk RYU, Seongnam-si (KR); Sun Min LEE, Seongnam-si (KR); Hong Quang NGUYEN, Seongnam-si (KR)

(21) Appl. No.: 16/782,968

(22) Filed: Feb. 5, 2020

(30) Foreign Application Priority Data
Jun. 3, 2019 (KR) 10-2019-0065619

(51) Int. Cl. G06F 9/48; H04L 1/18; H04L 29/06; H04L 12/879; G06F 5/06

(52) U.S. Cl. CPC G06F 9/4812; H04L 1/1816; G06F 5/06; H04L 49/901; H04L 69/164

(57) ABSTRACT

An apparatus for transmitting packets by using a timer interrupt service routine is provided. When a task for transmitting a user datagram protocol (UDP) packet occurs while a central processing unit processes at least one task, the apparatus generates a timer interrupt event for each time set considering a packet transmission interval and calls a timer interrupt service routine, and transmits a UDP packet at equal intervals to a destination by using the timer interrupt service routine.

### CROSS-REFERENCE TO RELATED APPLICATION

This application claims the benefit of Korean Patent Application No. 10-2019-0065619, filed on Jun. 3, 2019, in the Korean Intellectual Property Office, the disclosure of which is incorporated herein in its entirety by reference.

### BACKGROUND

### 1. Field

One or more embodiments relate to an apparatus for transmitting packets by using a timer interrupt service routine, and more particularly, to a technique for transmitting user datagram protocol (UDP) packets at equal intervals by using a timer interrupt service routine.

### 2. Description of Related Technology

An apparatus for transmitting packets, which generates packets by encoding a captured video in real time and transmits the generated packets to a destination, provides a multitasking structure. More specifically, the apparatus for transmitting packets may process a task of reproducing digital broadcast data, a task of executing an application, or a task of reproducing digital broadcast data in the background, as disclosed in the patent document.

The principle of multitasking is to execute one task, pause, execute another task, stop and execute another task, and eventually process all tasks. A user may sense as if several tasks are being processed at once.

In order to provide real time streaming, the apparatus for transmitting packets mainly uses a user datagram protocol (UDP) method rather than a transmission control protocol (TCP) method. The UDP method has a risk of packet loss due to one-sided transmission without considering flow congestion, but it is widely used for real-time streaming due to faster transmission and lower overhead than the TCP method. However, in related arts, if a task for transmitting a UDP packet is added when processing a plurality of tasks, it is necessary to wait for a time to receive a process license on a multitasking schedule. Therefore, packets are transmitted during a process license time, and the packet transmission is repeatedly interrupted while waiting for a next license grant. As a result, if a transmission interval between packets is denser than an average interval and the transmission speed of a packet exceeds the processing speed of a router while the packet is transmitted on a network, the packet is discarded at the router and does not reach a destination. In a TCP transmission method, there is a procedure for acknowledging the reception of each packet, and thus, even if a packet is discarded at the router, the same packet is retransmitted to overcome the discard. However, in a UDP transmission method, when a packet is discarded at the router, packet loss occurs.

Referring to the relationship between a transmission interval and a packet loss rate between UDP packets of the non-patent document below, the packet loss rate rapidly increases as the transmission interval decreases. In order to solve this problem, UDP packets have to be transmitted at evenly spaced intervals so as not to be densely transmitted.

In the related arts, a sleep method and a busy check method have been proposed to send packets at equal intervals. However, both methods have the following problems.

The sleep method is a method in which a UDP packet transmission task relinquishes a process license for the rest of the time after sending one packet and requests a multitasking scheduler to call the UDP packet transmission task itself again after a certain period of time to thereby reclaim the process license. However, the multitasking schedule manages the scheduling of tasks in tens of milliseconds, whereas a real-time video encoder has to send packets at intervals of several milliseconds to ensure transmission rates. Therefore, it is difficult to implement equal interval packet transmission in the sleep method.

The busy check method is a method in which a UDP packet transmission task transmits packets at regular intervals of several milliseconds while monopolizing a central processing unit. However, the busy check method has a problem that other tasks may not be executed by monopolizing the central processing unit.

### SUMMARY

In order to solve the above problem, one or more embodiments include a technique for generating a timer interrupt event for each time preset considering a packet transmission interval while a central processing unit processes at least one task and for calling a timer interrupt service routine to send a user datagram protocol (UDP) packet to a destination when the timer interrupt event is generated.

One or more embodiments include a technique for generating a header in a timer interrupt service routine without requesting, from a protocol stack of an operating system, a task of generating a header in encoded data.

One or more embodiments include a technique for changing only a rear pointer value when an encoder inserts data into a rear and changing only a front pointer value when a timer interrupt service routine takes out data from a front, wherein the encoder and the timer interrupt service routine may simultaneously access a payload queue and change pointer values.

Additional aspects will be set forth in part in the description which follows and, in part, will be apparent from the description, or may be learned by practice of embodiments of the disclosure.

According to one or more embodiments, an apparatus for transmitting packets by using a timer interrupt service routine includes: a central processing unit providing a multitasking structure and configured to stop and store a task in a current state when an interrupt occurs, urgently process an event related to the interrupt, and return to a state before the occurrence of the event when event processing is completed; a payload queue configured to provide a first-in first-out (FIFO) structure for enabling withdrawal of data at a front and insertion of data at a rear; a timer interrupt service routine configured to take out data from the front to generate a header when a timer interrupt event set considering a packet transmission interval occurs; a communication unit configured to transmit, to a destination, a user datagram protocol (UDP) packet including the data taken out from the front and the header, wherein UDP packets are transmitted at equal intervals by using the timer interrupt service routine.

The apparatus for transmitting packets by using a timer interrupt service routine may further include an encoding unit configured to change only a rear pointer value when inserting data into the rear, wherein the timer interrupt service routine may be further configured to change only a front pointer value when taking out data from the front, wherein the encoding unit and the timer interrupt service routine may be capable of accessing the payload queue and changing pointer values at the same time.

The timer interrupt service routine may be further configured to process a timer interrupt event for each of j destinations (where j is a natural number) when the timer interrupt event occurs at each transmission interval corresponding to each of the j destinations, wherein the communication unit may be further configured to transmit a UDP packet to each destination at a packet transmission interval and provide sequential UDP packet transmission for each destination every transmission interval for each destination.

When the same UDP packet needs to be transmitted to j destinations, one context switching and one copying of the same UDP packet from user space to kernel space may be performed, and the UDP packet copied to the kernel space may be repeatedly transmitted j times to the j destinations.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a block diagram illustrating an apparatus for transmitting packets by using a timer interrupt service routine, according to an embodiment of the disclosure.

FIG. 2 illustrates an example of a payload queue in which there is no data.

FIG. 3 illustrates an example of a payload queue from which data D1 is taken out.

FIG. 4 illustrates an example of a payload queue in which data D3 is inserted.

FIG. 5 illustrates an example of a payload queue in which data D1 is taken out and data D3 is inserted at the same time.

FIG. 6 illustrates an example of a payload queue in which data Dn+1 is inserted.

FIG. 7 illustrates user datagram protocol (UDP) packet transmission using a multitasking scheduler according to related arts.

FIG. 8 illustrates an example of UDP packet transmission using a timer interrupt service routine, according to an embodiment of the disclosure.

FIG. 9 illustrates an example of UDP packet transmission to a plurality of destinations, according to an embodiment of the disclosure.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

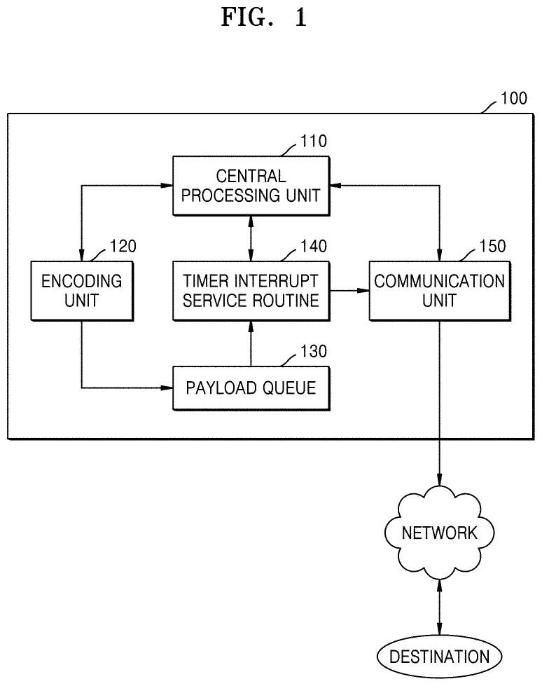

FIG. 1 is a block diagram illustrating an apparatus 100 (hereinafter, referred to as a packet transmission apparatus 100) for transmitting packets by using a timer interrupt service routine, according to an embodiment of the disclosure. The packet transmission apparatus 100 transmits a packet to a destination through a network. For example, the network is Ethernet and the destination includes at least one destination. The packet transmission apparatus 100 may include a central processing unit (CPU) 110, an encoding unit 120, a payload queue 130, a timer interrupt service routine (TISR) 140, and a communication unit 150.

The CPU 110 provides a multitasking or a multitasking structure. For example, the CPU 110 may process various tasks such as a task of playing a video, a task of transmitting a video, a task of executing a certain application, a task of executing music, a task of reading a document, or the like. However, the disclosure is not limited thereto.

When processing a plurality of tasks, the CPU 110 grants a process license in units of time set as a schedule for each task and provides a multitasking structure for processing tasks one by one.

The CPU 110 includes a control unit, an arithmetic logic unit, and at least one register. The control unit interprets program instructions and instructs the arithmetic logic unit, a main memory unit, or an input-output unit according to the meaning of the interpreted instructions. The arithmetic logic unit is a unit for performing an arithmetic and logical operation and performs the operation according to the instruction of the control unit.

The register is a space for storing instructions or data read from the main memory unit, or for storing a calculated result. The register is a storage location for storing information necessary for executing an instruction in the CPU 110, and may include a general purpose register and a special purpose register.

The general purpose register stores data related to operations during instruction execution. The special purpose register may include a program counter, an instruction register, and a stack pointer. The program counter stores an address of the main memory unit where an instruction to be executed next is stored, the instruction register stores an instruction currently being executed, and the stack pointer stores an address at which data insertion and withdrawal of a main memory unit stack occurs.

The CPU 110 provides a multitasking structure, stops and stores a task in a current state when an interrupt occurs, and urgently processes an event related to the interrupt. When the event is processed, the CPU 110 returns to a state before the event occurred.

The Interrupt is a function of a computer operating system that allows a task to continue even if an unexpected problem occurs while a computer is running, and means interrupting a running program and executing another program first.

The interrupt includes an internal interrupt and an external interrupt. The internal interrupt is an interrupt generated in a memory unit or the inside (e.g., the arithmetic logic unit) of the CPU 110, and is caused by a hardware failure, an inexecutable instruction, an instruction execution error, or a permission violation. The hardware failure is a computer failure, a bit error in a data transfer process, or a failure due to a power outage. The inexecutable instruction corresponds to a case in which a bit pattern of an instruction fetched from the memory unit is not defined. The instruction execution error corresponds to a case of executing division 0. The permission violation corresponds to a case where a user accesses a resource that may be used only by an operating system.

The external interrupt includes a timer interrupt and an input-output interrupt. The timer interrupt is an interrupt in which a timer requests, at regular time intervals, the CPU 110 to generate an interrupt. When the CPU 110 receives an event requesting an interrupt from the timer, the CPU 110 stops a task currently being executed and executes a timer interrupt service routine 140.

When the timer interrupt service routine 140 receives a command to process the event from the CPU 110, the timer interrupt service routine 140 executes code related to the event to process the interrupt for the event. In the timer interrupt service routine 140, a code corresponding to the event is registered in advance. When the CPU 110 receives an event requesting an interrupt from the timer, the CPU 110 resumes the stopped task when the timer interrupt service routine 140 processes the event and completes the event.

The input-output interrupt is an interrupt that is requested to the CPU to notify that a slow input-output unit is ready for input and output, or when the input-output unit has failed and is not operated.

The encoding unit 120 encodes a source video to generate data, and the payload queue 130 temporarily stores the source video of the encoder 120. The source video may be a video received through an external terminal such as High Definition Multimedia Interface (HDMI) or Serial Digital Interface (SDI), or may be a video stored in a storage medium. The payload queue 130 provides a first-in first-out (FIFO) structure for enabling withdrawal of data at the front thereof and insertion of data at the rear thereof.

When a timer interrupt event set considering a packet transmission interval occurs, a currently running task is immediately stopped and the timer interrupt service routine 140 is called and executed. The timer generates an interrupt requesting the CPU 110 to process a timer interrupt event at every packet transmission interval. The CPU 110 stops a currently running task and executes the timer interrupt service routine 140.

The timer interrupt service routine 140 extracts data of the front and generates a header.

The header includes a user datagram protocol (UDP) header, an Internet Protoco (IP) header, and a Multiple Analog Components (MAC) header. The UDP header may include information on a port number of a data transmit/receive destination, the IP header may include information on an IP address of the data transmit/receive destination and information about whether to use Transmission Control Protocol (TCP) or UDP, and the MAC header may include information on an MAC address of the data transmit/receive destination. Information included in the headers may include information regarding a destination, which indicates which path a UDP packet has to be transmitted to.

The communication unit 150 includes a network card and transmits a UDP packet including data taken out from the front and a header to a destination. The network card may be a MAC driver.

In the related arts, when a task for transmitting a UDP packet is added when processing a plurality of tasks, the packet has to be sent during a process license grant time, and thus, packets sent more closely than an average interval of packets may be lost due to Internet congestion during transmission. However, the packet transmission apparatus 100 according to an embodiment of the disclosure may transmit UDP packets to a destination at equal intervals close to the average interval of packets without having to wait for a process license grant.

It is assumed that the packet transmission apparatus 100 requires a transmission rate of 6 Mbps to ensure real time streaming reproduction at the destination. Ethernet packets are 1,500 bytes in size, and thus, 6 Mbps is a speed that may be achieved by sending approximately 500 packets per second. To evenly send 500 packets per second, a packet transmission interval is 2 ms on average. That is, packet transmission has to be performed within 2 ms. For example, in the case of the Linux operating system managing a multitasking schedule with a 20 ms time slice, in the related arts, 20 ms has to be waited to receive a process license grant, and thus, when equal interval UDP packet transmission is implemented by using a sleep method, a required transmission rate may not be achieved. However, the packet transmission apparatus 100 according to an embodiment of the disclosure transmits UDP packets at equal intervals by transmitting packets directly from the timer interrupt service routine 140 every 2 ms.

In the related arts, a method of requesting, from a protocol stack of an operating system, a task of adding a header of data is provided. However, since generating the header in the protocol stack of the operating system is one task that has to follow a multitasking schedule, a socket library call to use the protocol stack in the timer interrupt service routine 140 is not allowed. Thus, the packet transmission apparatus 100 according to an embodiment of the disclosure directly processes, in the timer interrupt service routine 140, a task of generating a header.

The packet transmission apparatus 100 according to an embodiment of the disclosure generates a timer interrupt event at a time set considering a packet transmission interval and calls and uses the timer interrupt service routine 140, and thus may transmit UDP packets at equal intervals while the CPU 110 processes at least one task and may reduce a loss rate of packets reaching a receiving side.

The packet transmission apparatus 100 according to an embodiment of the disclosure does not request, from a protocol stack of an operating system, a task of generating a header by using encoded data and directly generate the header in the timer interrupt service routine 140. A normal method of requesting a protocol stack of an operating system to generate a header undergoes a process of waiting for a license to be returned according to a multitasking schedule. However, due to the nature of the timer interrupt service routine 140 for emergency processing, the process of waiting for a license is not allowed in the packet transmission apparatus 100 according to an embodiment of the disclosure.

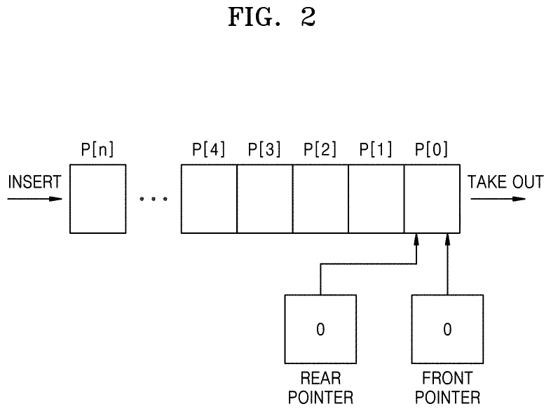

FIG. 2 illustrates an example of a payload queue in which there is no data, and the payload queue 130 has a FIFO structure in which data is inserted at one side and data is withdrawn at the other side. The place where data insertion takes place is called a rear, and the place where data withdrawal takes place is called a front. The payload queue 130 has a one-dimensional array of [1:n] and has a rear pointer indicating a position at which data is inserted and a front pointer indicating a position at which data is taken out.

The encoding unit 120 and the timer interrupt service routine 140 may check whether the payload queue 130 is empty or full with data. The encoding unit 120 reads a rear pointer value and a front pointer value to check whether new data may be inserted, and the timer interrupt service routine 140 reads the rear pointer value and the front pointer value to check whether there is data to be extracted. As shown in FIG. 2, the encoding unit 120 and the timer interrupt service routine 140 may recognize that the payload queue 130 is empty when the rear pointer value and the front pointer value are read as zero.

A race condition refers to a condition in which two or more inputs or manipulations occur at the same time resulting in unintended results. More specifically, the race condition refers to a condition that may affect a result related to the timing or order of access when multiple processes simultaneously attempt to access a shared resource. In the related arts, in order to solve a race condition, a lock function is provided to lock another process from accessing a shared resource while one process occupies the shared resource. However, in the related arts, when another process accesses a shared resource when a UDP packet is to be transmitted, it has to be waited until another process's task is completed. Therefore, a transmission delay may occur and a process of locking a certain variable to prevent a race condition may not be included in the timer interrupt service routine 140. In the packet transmission apparatus 100 according to an embodiment of the disclosure, although the encoding unit 120 and the timer interrupt service routine 140 access the front pointer and the rear pointer and read their values to check whether the payload queue 130 is full with data or empty, a locking process for preventing a race condition is not provided considering that only the rear pointer value is rewritten by the encoding unit 120 and only the front pointer value is rewritten by the timer interrupt service routine 140.

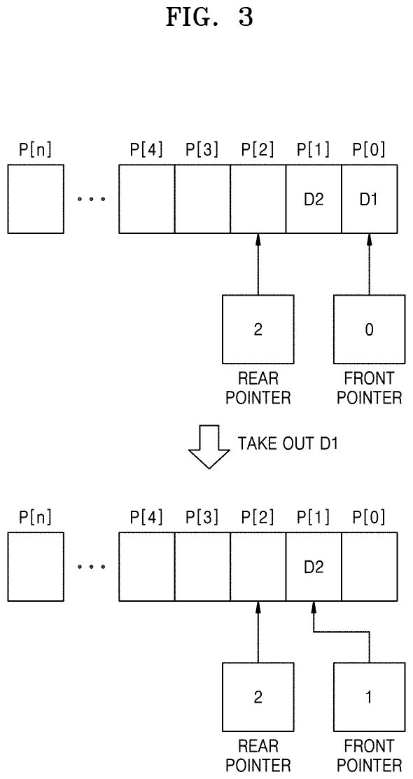

FIG. 3 illustrates an example of a payload queue from which data D1 is taken out. In the example illustrated in FIG. 3, the encoding unit 120 changes a rear pointer value when data is inserted into the rear of the payload queue, and the timer interrupt service routine 140 changes a front pointer value when data is taken out from the front of the payload queue.

The timer interrupt service routine 140 reads the rear pointer value and the front pointer value of the payload queue 130 and checks whether there is data to be taken out, and when it is checked that there is data to be taken out, for example, data D1 located at a front pointer 0, the timer interrupt service routine 140 takes out the data D1 and changes the front point value from 0 to 1. Changing the front point value from 0 to 1 denotes that the current front pointer is moved one space to the left.

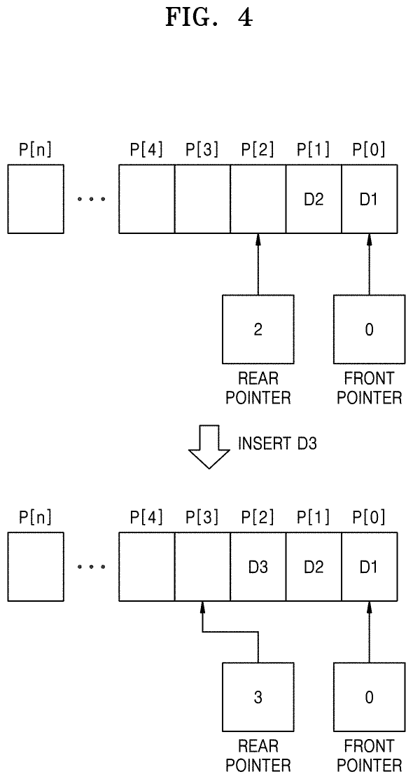

FIG. 4 illustrates an example of a payload queue in which data D3 is inserted. The encoding unit 120 reads a rear pointer value and a front pointer value of the payload queue 130 to check whether the payload queue 130 is full with data, and when it is checked that an array located at a rear pointer 2 is empty, the encoding unit 120 inserts the data D3 into the array located at the rear pointer 2 and changes the rear pointer value from 2 to 3. Changing the rear pointer value from 2 to 3 denotes that the current rear pointer is moved one space to the left.

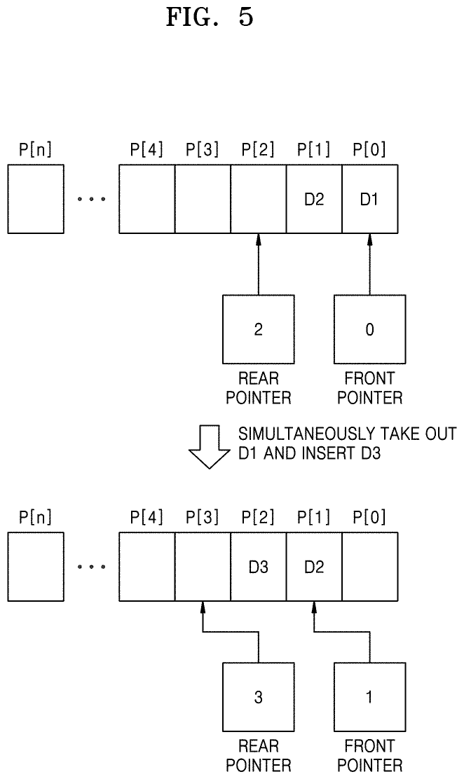

FIG. 5 illustrates an example of a payload queue in which data D1 is taken out and data D3 is inserted at the same time. The encoding unit 120 and the timer interrupt service routine 140 may simultaneously access the payload queue 130 storing shared resources and change the rear and front pointer values.

In the packet transmission apparatus 100 according to an embodiment of the disclosure, the encoding unit 120 and the timer interrupt service routine 140 may access the payload queue 130 and change the rear and front pointer values, at the same time without affecting each other, thereby eliminating the need for a locking process for preventing a race condition. In a method in which one side locks a variable in order to avoid problems caused as both sides change the variable at the same time, there is a possibility that one side has to wait until the lock is released, if the variable is locked by the other side in advance. Therefore, the packet transmission apparatus 100 according to an embodiment of the disclosure does not allow the possibility described above due to the nature of an interrupt routine for urgent processing.

In the packet transmission apparatus 100 according to an embodiment of the disclosure, since the encoding unit 120 rewrites data only to the rear pointer and the timer interrupt service routine 140 rewrites data only to the front pointer, there is no state in which two tasks access and change one data at the same time.

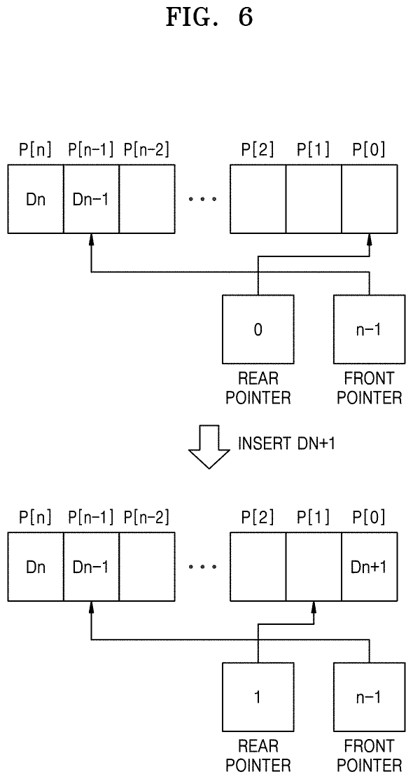

FIG. 6 illustrates an example of a payload queue in which data Dn+1 is inserted. The encoding unit 120 checks whether the rear pointer value of the payload queue 130 is a maximum value such as n+1 and checks whether the front pointer value exceeds 0. When both conditions are confirmed, the encoding unit 120 changes the rear pointer value n+1 to 0. The packet transmission apparatus 100 according to an embodiment of the disclosure may improve storage efficiency by comparing the rear pointer value and the front pointer value of the payload queue 130 with a limited storage space.

The CPU 110 stops and stores a task in a current state when a timer interrupt event occurs while processing at least one task, and the timer interrupt service routine 140 processes the timer interrupt event. When the processing of the timer interrupt event is completed, the CPU 110 returns to a state before the timer interrupt event occurred

While the timer interrupt service routine 140 is running, there is an action that interrupts at least one task that normally operates at the CPU 110, and thus, it is not permitted to include tasks, which need to wait or are likely to wait, in the timer interrupt service routine 140, to reduce the execution time of the timer interrupt service routine 140. More specifically, calling a relevant library to request, from an operating system's protocol stack, a task of generating a header is not allowed in the timer interrupt service routine 140 because it is waited or is likely to be waited to receive a process license grant, like a normal task, and thus, the timer interrupt service routine 140 directly processes the task of generating a header. Also, locking the front pointer to prevent a race condition is also not allowed in the timer interrupt service routine 140 because it is likely to be waited until a locked state is released if the same variable is locked already by another task. Therefore, the timer interrupt service routine 140 immediately rewrites data to the front pointer without locking the front pointer.

Both the timer interrupt service routine 140 and the encoding unit 120 access the front point, but the encoding unit 120 only reads the front point value and does not write the front point value, and thus, a race condition does not occur. Therefore, even if the front pointer value is directly written without a locking process in the timer interrupt service routine 140, an unintended error does not occur.

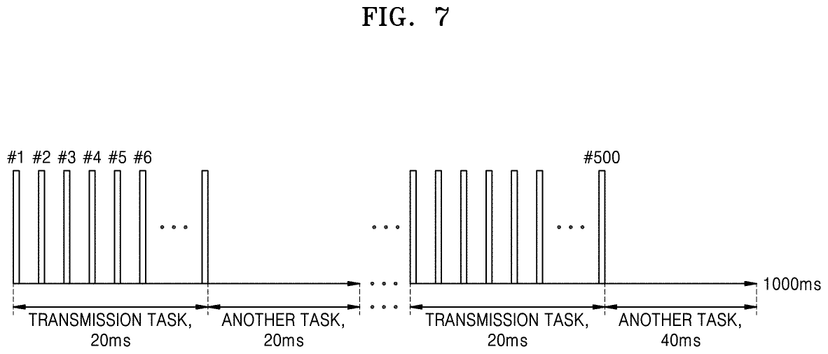

FIG. 7 illustrates UDP packet transmission using a multitasking scheduler according to the related arts. For example, it is assumed that one UDP packet includes 1500 bytes, 6 Mbits are transmitted from a source to a destination during 1 second, and a task interval allocated to the multitasking scheduler is 20 ms or 40 ms. In the related arts, transmission tasks are peformed only in an allotted time, thus intervals between packets may be very tight, to maintain 6 Mbps, or to reproduce videos in real time. More specifically, in the related arts, since packets are transmitted during a process license time and the packet transmission is repeatedly interrupted while waiting for a next license grant, a transmission interval between the packets is denser than an average interval and thus their flow may exceed momently the processing capacity of an router. In the related arts, when the router is not able to process the packet flow momently, a packet is discarded at the router and does not reach a destination.

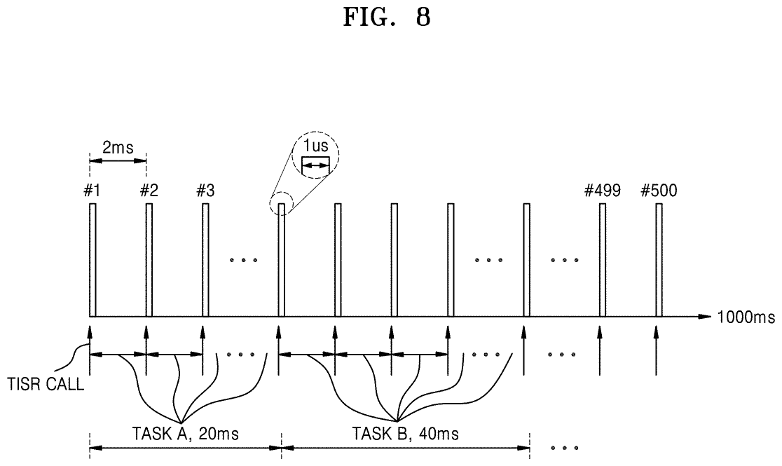

FIG. 8 illustrates an example of UDP packet transmission using a timer interrupt service routine, according to an embodiment of the disclosure. An embodiment of the disclosure provides a technique for generating a timer interrupt event for each time set considering a packet transmission interval of 2 ms and for calling a timer interrupt service routine to send a UDP packet to a destination when the timer interrupt event is generated. The timer interrupt service routine 140 is called every 2 ms and may take several microseconds (μs) (e.g., 1 μs) to generate a header and transfer the header to the communication unit 150. Since the CPU 110 takes 1 μs each time the timer interrupt service routine 140 operates, the CPU 110 returns to the state before an event occurred when the timer interrupt service routine 140 processes and completes the event. The CPU 110 may process tasks according to the schedule of the multitasking scheduler until the call of the timer interrupt service routine 140 occurs again.

The packet transmission apparatus 100 according to an embodiment of the disclosure may transmit UDP packets at equal intervals by using the timer interrupt service routine 140 and may perform other tasks during the remaining time (e.g., within 2 ms) between transmission intervals except for a time required for transmission when the UDP packets are transmitted at equal intervals. The packet transmission apparatus 100 according to an embodiment of the disclosure may reduce the risk of packet loss by uniformly transmitting UDP packets at equal intervals and may improve system efficiency by performing other tasks during the remaining time between transmission intervals except for a time required for transmission.

In the related arts, j context switchings and j copyings may be performed from user space to kernel space to transmit UDP packets to j destinations. However, in the related arts, context switching and copying may occur for each destination, resulting in system overload or power consumption increase.

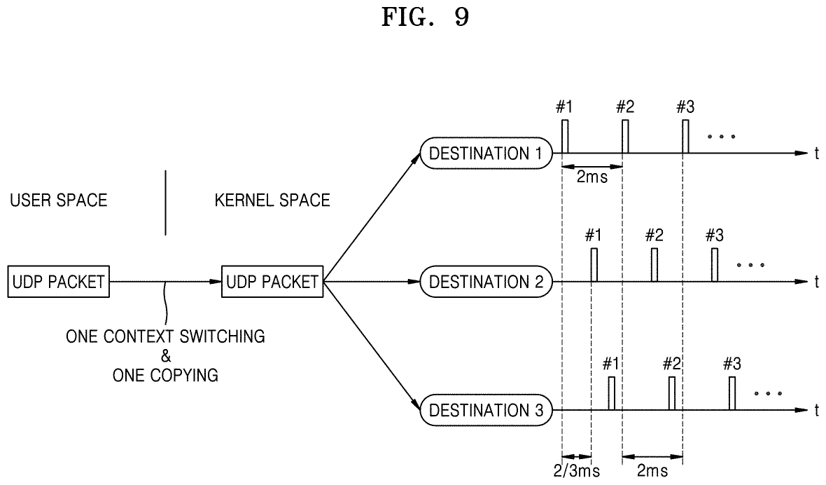

FIG. 9 illustrates an example of UDP packet transmission to a plurality of destinations, according to an embodiment of the disclosure. When the same UDP packet needs to be transmitted to j destinations, the packet transmission apparatus 100 performs one context switching and one copying of the same UDP packet from user space to kernel space, repeatedly transmits the UDP packet copied to the kernel space j times to the j destinations, and transmits the UDP packet to each destination at packet transmission intervals. FIG. 9 illustrates an example in which there are three destinations, and the packet transmission apparatus 100 may repeatedly transmit a UDP packet three times to three destinations.

The packet transmission apparatus 100 according to an embodiment of the disclosure may call a destination transfer function in kernel space to transmit, to j destinations, a UDP packet once copied. In the packet transmission apparatus 100 according to an embodiment of the disclosure, the timer interrupt service routine 140 may be used as the destination transfer function. In the packet transmission apparatus 100 according to an embodiment of the disclosure, the load and power consumption of the packet transmission apparatus 100 may be reduced as one context switching and one copying of the UDP packet is performed.

When a timer interrupt event occurs at each transmission interval corresponding to each of the j destinations, the timer interrupt service routine 140 may process the timer interrupt event for each of the j destinations (where j is a natural number). For example, when UDP packets are transmitted to a single destination as shown in FIG. 8, the timer interrupt service routine 140 may be called at intervals of 2 ms in order to transmit the UDP packets for the single destination. Also, as shown in FIG. 9, when UDP packets are transmitted to three destinations, the timer interrupt service routine 140 may be called at intervals of 2/3 ms in order to transmit the UDP packets to three destinations. As illustrated in FIG. 9, the communication unit 150 may transmit a UDP packet to each destination at a packet transmission interval of 2 ms and provide sequential UDP packet transmission for each destination for every transmission interval of 2/3 ms for each destination.

The packet transmission apparatus 100 according to an embodiment of the disclosure may perform other tasks during the remaining time (e.g., within 2/3 ms) between transmission intervals for each destination except for a time required for transmission when UDP packets are transmitted at equal intervals to j destinations. In addition, the packet transmission apparatus 100 according to an embodiment of the disclosure may adjust an interval at which the timer interrupt service routine 140 is called considering the number of destinations, may transmit the same data to a plurality of destinations at equal intervals, and may reduce the number of context switchings and data copyings performed between user space and kernel space.

The packet transmission apparatus 100 according to an embodiment of the disclosure may generate a timer interrupt event at a time set considering a packet transmission interval and call a timer interrupt service routine, and thus, may transmit UDP packets at equal intervals while the CPU 110 processes at least one task and may reduce a loss rate of packets reaching a receiving side.

The packet transmission apparatus 100 according to an embodiment of the disclosure generates a header, directly in a timer interrupt service routine, without having to request an operating system's protocol stack to generate a header by using encoded data.

In the packet transmission apparatus 100 according to an embodiment of the disclosure, the encoding unit 120 and the timer interrupt service routine 140 may access the payload queue 130 and change the rear and front pointer values, at the same time without affecting each other, thereby eliminating the need for a locking process for preventing a race condition.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An apparatus for transmitting packets by using a timer interrupt service routine, the apparatus comprising:
a central processing unit configured to stop at least one task, which is currently running, when a timer interrupt event set considering a packet transmission interval occurs, call a timer interrupt service routine, and resume the stopped at least one task when processing of the timer interrupt event is completed;
a payload queue configured to provide a first-in first-out (FIFO) structure for enabling withdrawal of data at a front and insertion of data at a rear;
a timer interrupt service routine configured to take out data from the front and generate a header when receiving a call to process the timer interrupt event from the central processing unit; and
a communication unit configured to transmit, to a destination, a user datagram protocol (UDP) packet including the data taken out from the front and the header,
wherein the timer interrupt service routine is further configured to be executed every time a timer interrupt event occurs to enable UDP packet transmission at equal intervals even while at least one task is processed, and
wherein the central processing unit is further configured to process at least one task during a remaining time between packet transmission intervals except for a time required for transmission.

2. The apparatus of claim 1, further comprising:
an encoding unit configured to change only a rear pointer value when inserting data into the rear,
wherein the timer interrupt service routine is further configured to change only a front pointer value when taking out data from the front, and
wherein the encoding unit and the timer interrupt service routine are configured to access the payload queue and change pointer values at the same time.

3. The apparatus of claim 1, wherein the timer interrupt service routine is further configured to process a timer interrupt event for each of j destinations (where j is a natural number) when the timer interrupt event occurs at each transmission interval corresponding to each of the j destinations, and
wherein the communication unit is further configured to transmit a UDP packet to each destination at a packet transmission interval and provide sequential UDP packet transmission for each destination every transmission interval for each destination.

4. The apparatus of claim 1, wherein, when same UDP packet needs to be transmitted to j destinations, one context switching and one copying of the same UDP packet from user space to kernel space is performed, and the UDP packet copied to the kernel space is configured to be repeatedly transmitted j times to the j destinations.
